(19) United States
(12) Patent Application Publication
(10) Pub. No.: US 2006/0294317 A1
(43) Pub. Date: Dec. 28, 2006

(54) Symmetric multiprocessor architecture with interchangeable processor and IO modules

(76) Inventor: Stuart Allen Berke, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/158,419

(22) Filed: Jun. 22, 2005

(51) Int. Cl. G06F 13/28

(52) U.S. Cl. 711/141

(57) ABSTRACT

A symmetric multiprocessor (“SMP”) computer architecture with interchangeable processor and input/output (“IO”) modules is disclosed. In one embodiment, the computer comprises a circuit board to interconnect processor modules and IO modules that are interchangeable with each other. Each of the interchangeable modules includes a portion of a cache-coherent system memory.

### BACKGROUND

A popular architecture in commercial multiprocessor computer systems is the symmetric multiprocessor (“SMP”) architecture. The original SMP architecture is characterized by a shared memory that is uniformly accessible to each processor via one or more shared buses. The shared memory model aids programmers by negating any need for data partitioning and simplifying task distribution among various processors. However, scalability of the original SMP architecture is inhibited by the processors' contention for access to the shared memory and the shared buses. These bottlenecks can be eased somewhat by the use of individual caches for each processor, but system performance still reaches a maximum with relatively few processors.

Accordingly, various modifications and alternatives to the original SMP architecture have been explored. One promising modification of the original SMP architecture is the distributed shared memory SMP architecture. In this architecture each processor has access to all of the shared memory, but some (local) portions of the memory can be accessed more quickly than other (remote) portions of the memory. Commercial computer systems of this type include multiple processing nodes connected via a high-bandwidth, low latency interconnection network. The processing nodes each include one or more high-performance processors with associated cache memory, and a portion of the global shared memory. To prevent different cache memories from acquiring inconsistent views of the memory contents, a cache coherence protocol is employed. One cache coherence protocol example is the directory-based write-invalidate protocol. Each processing node maintains a directory to identify holders of any given portion of local memory and to notify those holders when that portion is being modified.

One problem faced by computer manufacturers is the cost required to develop high-performance computer systems. Because the market for such systems is relatively small, the development cost is quite large on a per-sale basis. To maximize the market size, and thereby reduce the risk of losing money, high-end computer manufacturers must design high performance systems that are as flexible as possible.

### BRIEF DESCRIPTION OF THE DRAWINGS

For a detailed description of various illustrative embodiments, reference will now be made to the accompanying drawings in which:

FIG. 1 shows an illustrative network having a computer with a cellular symmetric multiprocessor (“SMP”) architecture according to an embodiment of the present invention;

FIG. 2 shows an illustrative computer with a cellular SMP architecture according to an embodiment of the present invention;

FIG. 3 shows a block diagram of an illustrative processor module according to an embodiment of the present invention;

FIG. 4 shows a block diagram of an illustrative input/output (“IO”) module according to an embodiment of the present invention; and

FIG. 5 show an isometric view of another illustrative IO module according to an embodiment of the present invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various illustrative embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be illustrative of that embodiment, and not intended to suggest that the scope of the disclosure, including the claims, is limited to that embodiment.

FIG. 1 shows an illustrative environment for a computer 102 having a cellular symmetric multiprocessor (“SMP”) architecture. Computer 102 operates as a high-performance computing center where solutions to complex problems are found. Alternatively, computer 102 operates as a server that provides access to files stored in storage array 104 and supports execution of centralized software applications. In either case, server 102 operates under remote control from other servers 108 and personal computers 110 that communicate with server 102 via network 106.

To maximize flexibility, computer 102 is constructed using a cellular SMP architecture. The architecture provides interchangeable processor cell boards and input/output (“IO”) cell boards, enabling the computer configuration to be customized for its intended use. In other words, the cell boards can be freely exchanged, so that processor cell board in any slot can be replaced with an IO cell board and vice versa. Where empty slots are available, each empty slot can be filled with the user's choice of a processor cell board or an IO cell board. Such interchangeability maximizes flexibility. System upgrades are easier to install and the ratio of processor cell boards to IO cell boards can be readjusted as IO performance improves faster than processor performance.

The unconstrained intermixing of processor cell boards and IO cell boards also allows a processor cell board to be placed in a slot adjacent to its supporting IO cell board(s). Because the backplane is configurable to isolate different groups of cell boards, this ability to localize hardware translates into an ability to create multiple independent computing systems within one cabinet. In this manner, the use of a cellular SMP architecture simplifies “partitioning” the computer's resources to implement multiple independent computing systems.

FIG. 2 shows an illustrative cellular SMP computer 102 without an outer shell. The computer chassis includes a lower bay 202 and an upper bay 204. Each bay has slots 206 for up to eight cell boards. A backplane circuit board 208 is provided for interconnecting the cell boards. The cell boards come in two types: IO cell boards 210 and processor cell boards 212. The boards are packaged as interchangeable modules, allowing the mix of IO and processor resources to be customized and easily updated. The cell boards are vertically oriented to allow for a bottom-to-top cooling air flow, though of course other cooling methods can be employed. The computer 102 includes two blowers 214 to draw cooling air across the cell boards, and further includes redundant power supplies 216.

FIG. 3 shows a block diagram of an illustrative processor cell board 212. The processor cell board 212 includes one or more processors 302, 304, a set of agents 306-309, and a set of SMP memory modules 316-319. The number of processors is varied to provide processor cell boards with different computing capacities. In one contemplated implementation, processor cell boards are made available in one-, two-, and four-processor configurations. In multi-processor cell boards, a direct communications link is provided between the processors.

The memory modules 316-319 each include one or more memory buses with one or more memory chip sockets per bus. Each memory module 316-319 is coupled to a corresponding agent 306-309 that implements a memory controller function with a directory to maintain cache coherence. In addition, the agent operates as a multi-port switch, routing addressed data and/or messages between ports for the memory module, the one or more processors, and the backplane (or centerplane) connections.

The backplane 208 includes crossbar switches that route addressed data and/or messages between the interchangeable modules. The crossbar switches is configured with redundant links to provide additional bandwidth between any two modules. The crossbar switches is configurable to block any attempted communications between particular ports, thereby providing an easy means for partitioning computer system into independent subsystems. (Such disabling serves as a means for isolating faulty communications paths and/or supporting automatic system failover.) Each subsystem includes at least one processor cell board and at least one IO cell board.

FIG. 4 shows a block diagram of an illustrative IO cell board 210. The IO cell board 210 includes one or more IO hubs (“IOHs”) 402, 404, a set of agents 406-409, and a set of SMP memory modules 416-419. The agents and memory modules operate in the same manner as the agents and memory modules on the processor cell boards, and are made identical on all types of the interchangeable modules. In particular, the agents on I/O cell board 210 each implement a memory controller function with a directory to maintain cache coherence, and operate as a multiport switch, routing addressed data and/or messages between ports for the memory module, the one or more I/O hubs, the backplane/centerplane connections, and other agents. On board 210, the agents 406-409 are configured into a ring with direct links between the agents, though many other configurations are also suitable.

The number of IOHs is varied to provide IO cell boards with different IO bandwidth capacities. In one contemplated implementation, IO cell boards are made available in one- and two-IOH configurations. Each IOH 402, 404 is coupled to multiple IO adapters 420 that reside on the IO cell board 210. As used herein, the term “IO adapter” refers to an add-in card or module that installs into a standardized “slot” and that bridges from the system's general purpose internal IO bus to an application specific external IO interface (e.g., Ethernet, SCSI, Fiberchannel, SAS, T1, ATM, proprietary link, etc.). In one embodiment, the general purpose IO buses are based on PCI Express technology and the IO adapters are PCI Express Server IO Modules. In other embodiments, general purpose I/O bus and I/O adapters are: PCI with Compact PCI Modules, PCI Express with Advanced TCA modules, InfiniBand with InfiniBand modules, and VMEbus with VME modules.

The IOHs 402, 404 operate as bridges between the SMP system coherency domain and the system's general purpose IO bus. There are a plurality of these in a large SMP system to provide the required number of IO slots and performance level. The IO adapters 420 are individually removable and in many embodiments they may be hot-swappable.

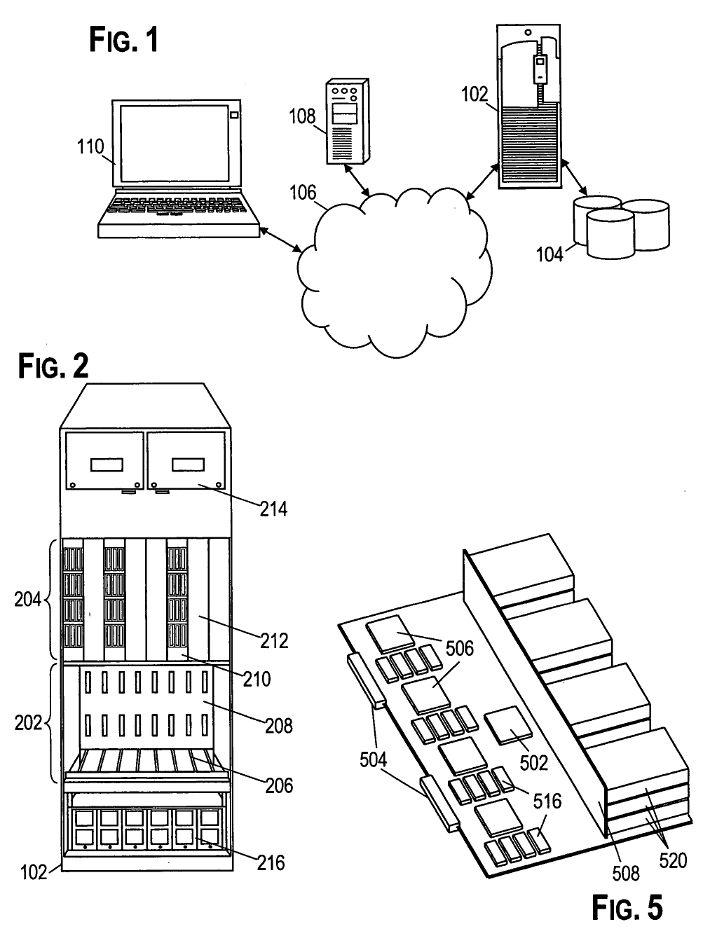

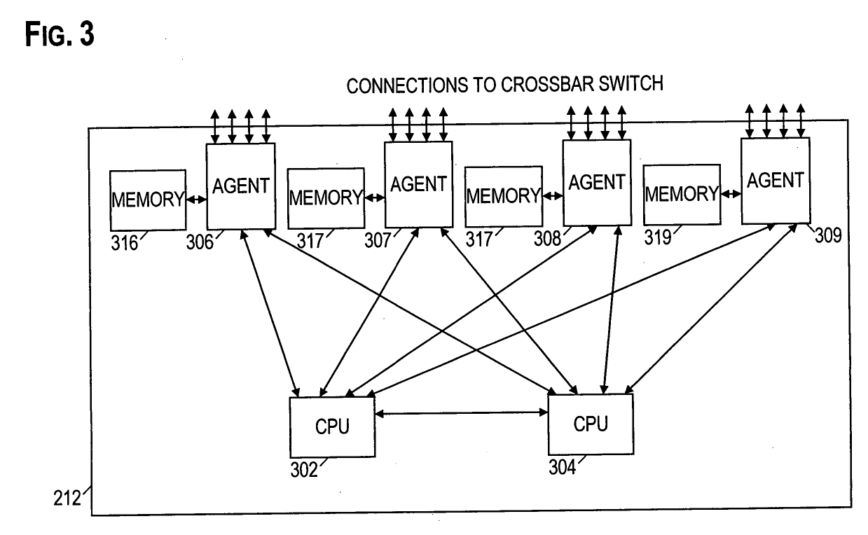

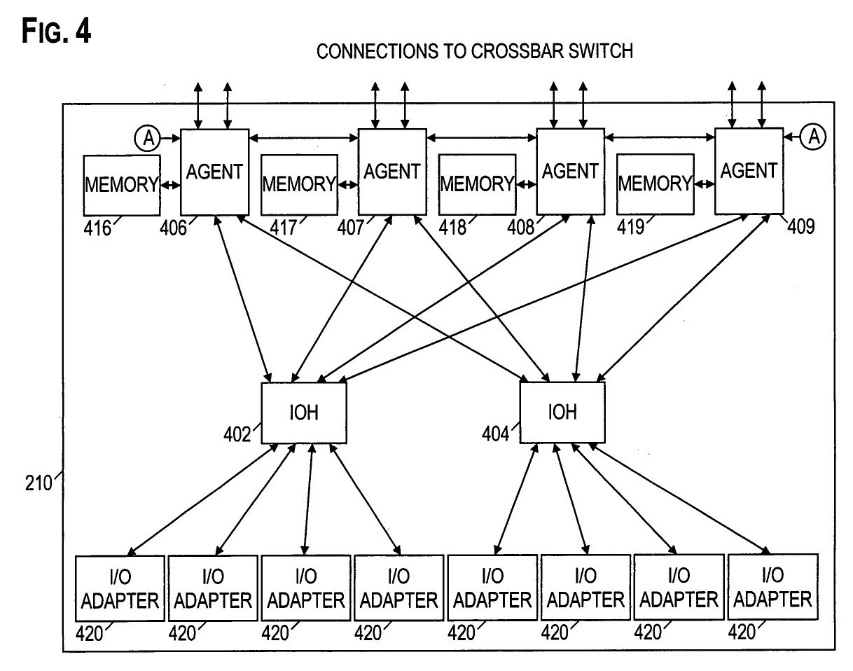

FIG. 5 shows an isometric view of an illustrative IO cell board 210. The IO cell board includes an IOH 502, a set of agents 506, a set of memory modules 516, and one or more backplane connectors 504. The IO cell board further includes a riser plane 508 having slots or sockets to accept the adapter modules 520. The illustrative board has twelve adapter modules attached, but the maximum number of slots depends on the form factor for the interchangeable modules.

The foregoing architecture with interchangeable modules, each module having a portion of the cache-coherent SMP memory, offers a substantial reduction in IO latency versus traditional large SMP architectures. With existing chip technology, architectures that confine the SMP memory to processor boards have a relatively high IO latency, which is insufficient to deliver full performance of next generation of 10-100 Gb/s IO devices. Conversely, the proposed architecture places a portion of the SMP memory on the IO cell board, and further places the IO adapters on the IO cell board, allowing IO adapter device drivers to advantageously allocate IO cell board local memory for IO buffers transfers. With existing chip technology, this architecture can obtain an IO latency of about half that of traditional large SMP architectures, which is sufficient to support full performance of both the next generation (10 Gb/s) and the following generations (40-100 Gb/s) of IO devices.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A symmetric multi-processor (“SMP”) computer that comprises:
a circuit board having sockets;
a processor module coupled to one of said sockets; and
an IO module coupled to one of said sockets,
wherein the processor module and the IO module are members of a set of interchangeable modules, each module in the set having a portion of a cache-coherent system memory.

2. The computer of claim 1, wherein the circuit board comprises one or more crossbar switches that couple together the set of interchangeable modules.

3. The computer of claim 1, wherein each module in the set further includes an agent coupled to the portion of the cache-coherent system memory and configured to maintain cache coherence information for that portion in a directory.

4. The computer of claim 3, wherein the agent in each module is further configured to couple the portion of cache-coherent system memory to other modules in the set via the circuit board.

5. The computer of claim 4, wherein on the processor module, the agent is further configured to couple one or more processors to the portion of cache coherent system memory and to other modules in the set.

6. The computer of claim 4, wherein on the IO module, the agent is further configured to couple one or more IO hubs to the portion of cache-coherent system memory and to other modules in the set.

7. The computer of claim 6, wherein the IO module further comprises one or more sockets for coupling to IO adapters.

8. The computer of claim 7, wherein the one or more sockets are located on a riser board extending substantially perpendicular to an IO board that is inserted in a socket on said circuit board.

9. The computer of claim 8, wherein the IO module is configured to support hot-swapping of the IO adapters.

10. The computer of claim 9, wherein the circuit board is configured to support hot-swapping of members of the set of interchangeable modules.

11. A computer that comprises:
a chassis having slots to receive cellular modules of at least two interchangeable types, the types including a processor type and an IO type;
at least one cellular module of the processor type; and
at least one cellular module of the IO type, wherein each cellular module of the IO type has at least one IO adapter.

12. The computer of claim 11, wherein cellular modules of the IO type each include a portion of system memory.

13. The computer of claim 11, wherein cellular modules of all interchangeable types each include a portion of system memory.

14. The computer of claim 13, wherein cellular modules of all interchangeable types each include memory controller agents that couple to each other via a backplane or centerplane in the chassis.

15. The computer of claim 13, wherein cellular modules of all interchangeable types each include memory controller agents configured to couple to each other via one or more crossbar modules.

16. The computer of claim 13, wherein cellular modules of all interchangeable types each include crossbar modules that couple the memory controller agents together via a backplane or centerplane in the chassis.

17. The computer of claim 13, wherein the IO adapter is a removable PCI Express Server I/O Module.

18. The computer of claim 13, wherein the cellular modules of the IO type include removable IO adapters for IO Gigabit Ethernet, Infiniband, or Fiberchannel links.

19. The computer of claim 31, wherein cellular modules of all interchangeable types each have the same outer physical form factor and each provide similar cooling paths.

20. An IO cell board for use in a computer, the IO cell board comprising:
a memory module;
a memory controller agent coupled to the memory module and configured to maintain the memory module as part of a cache-coherent memory domain; and
an IO hub coupled to the memory controller agent and configured to operate as a bridge between the cache-coherent memory domain and a general purpose IO bus,
wherein the IO cell board has a form factor allowing the IO cell board to be interchangeable with a processor cell board for said computer.

21. The IO cell board of claim 20, further comprising:
a plurality of removable IO adapters configured to couple the IO hub to corresponding IO devices.

22. The IO cell board of claim 20, further comprising a plurality of embedded or integrated IO adapters configured to couple the IO hub to the corresponding IO devices.

23. A computer that comprises:
IO means for supporting input/output communications;
processor means for operating on information received via input/output communications;
coupling means for connecting cache coherent memory controller means in each of the IO means and the processor means, wherein the coupling means receives the IO means and the processor means in an interchangeable fashion.

24. The computer of claim 23, wherein the processor means comprises a portion of a cache-coherent system memory and multiple processors, and wherein the cache coherent memory controller means interconnects the multiple processors, the portion of cache-coherent system memory, and the coupling means.

25. The computer of claim 23, wherein the IO means comprises a portion of a cache-coherent system memory and a hub means, and wherein the cache coherent memory controller means interconnect the hub means, the portion of cache coherent system memory, and the coupling means.
